(19) United States
(12) Patent Application Publication
(10) Pub. No.: US 2018/0373866 A1
(43) Pub. Date: Dec. 27, 2018

(54) CYBER SECURITY SYSTEM FOR A VEHICLE

(71) Applicant: Sikorsky Aircraft Corporation, Stratford, CT (US)

(72) Inventors: Gregory S. Sweeney, Wilton, CT (US); Christopher Dana Sargent, Beacon Falls, CT (US); Kyle Delong, Wallingford, CT (US)

(73) Assignee: Sikorsky Aircraft Corporation, Stratford, CT (US)

(21) Appl. No.: 15/757,912

(22) PCT Filed: Sep. 7, 2016
(86) PCT No.: PCT/US2016/050483

§ 371 Date: Mar. 6, 2018

Related U.S. Application Data
(60) Provisional application No. 62/215,212, filed on Sep. 8, 2015.

(51) Int. Cl. G06F 21/55; H04L 29/06; H04L 29/08

(52) U.S. Cl. CPC G06F 21/554; G06F 2221/034; H04L 67/12; H04L 63/1425

(57) ABSTRACT

A method of providing cyber security for a vehicle includes monitoring, by a cyber security system of the vehicle, a plurality of parameters acquired from at least one communication bus of the vehicle. The parameters are filtered to identify parameters of interest for cyber security threat detection. An evaluation of the parameters of interest is performed with respect to one or more of normal conditions and abnormal conditions to identify at least one likely cyber security threat in the vehicle based on identifying at least one condition that does not match the normal conditions or at least one condition that does match the abnormal conditions. One or more recovery actions are triggered based on identifying the at least one likely cyber security threat in the vehicle.

### BACKGROUND

The subject matter disclosed herein generally relates to computer system security, and more particularly to a cyber security system for a vehicle.

Vehicles typically include a number of interconnected computer systems that are linked by one or more communication buses. The computer systems include software (e.g., firmware) that may support updates in the field using a maintenance computer system via a wired or wireless link. One form of security risk that the computer systems may be susceptible to is loading of malware, such as Trojan horses, viruses, data corruption programs, and the like. If malware is successfully loaded onto one or more of the computer systems, the operator of the vehicle may lose control of the vehicle and/or may experience degraded vehicle performance.

### BRIEF DESCRIPTION

According to an aspect of the invention, a method of providing cyber security for a vehicle includes monitoring, by a cyber security system of the vehicle, a plurality of parameters acquired from at least one communication bus of the vehicle. The parameters are filtered to identify parameters of interest for cyber security threat detection. An evaluation of the parameters of interest is performed with respect to one or more of normal conditions and abnormal conditions to identify at least one likely cyber security threat in the vehicle based on identifying at least one condition that does not match the normal conditions or at least one condition that does match the abnormal conditions. One or more recovery actions are triggered based on identifying the at least one likely cyber security threat in the vehicle.

In addition to one or more of the features described above or below, or as an alternative, further embodiments could include where the evaluation of the parameters of interest includes performing one or more of: a static evaluation, a dynamic evaluation, and a predictive evaluation of the parameters of interest with respect to one or more of the normal conditions and the abnormal conditions as separately defined for each of the static evaluation, the dynamic evaluation, and the predictive evaluation.

In addition to one or more of the features described above or below, or as an alternative, further embodiments could include where the static evaluation includes performing at least one of a character evaluation and a boundary value check of at least one of the parameters of interest; the dynamic evaluation includes performing at least one of a deterministic process analysis and a stochastic process analysis on at least one of the parameters of interest; and the predictive evaluation includes performing at least one of an extrapolation and a finite set value verification of at least one of the parameters of interest.

In addition to one or more of the features described above or below, or as an alternative, further embodiments could include performing a confidence assessment with respect to one or more result of the static evaluation, the dynamic evaluation, and the predictive evaluation. The one or more recovery actions to take within the vehicle are determined based on a result of the confidence assessment, wherein the confidence assessment assigns a likelihood value to the at least one likely cyber security threat.

In addition to one or more of the features described above or below, or as an alternative, further embodiments could include monitoring at least one local sensor, by the cyber security system, to determine one or more of: an operating condition of the vehicle; a deviation with respect to one or more of the parameters; and an attempt to tamper with the cyber security system.

In addition to one or more of the features described above or below, or as an alternative, further embodiments could include receiving an upload comprising one or more of an application and a data file from a maintenance system. One or more of a version and a digital signature associated with one or more of the application and the data file are checked. At least one of the one or more recovery actions are triggered based on identifying at least one unexpected value for one or more of the version and the digital signature associated with one or more of the application and the data file.

In addition to one or more of the features described above or below, or as an alternative, further embodiments could include recording observations and results associated with the evaluation of the parameters of interest as forensic data. The forensic data are output from the cyber security system based on receiving an authorized request.

In addition to one or more of the features described above or below, or as an alternative, further embodiments could include where the one or more recovery actions include one or more of: an alert function that triggers an alert to one or more systems of the vehicle as a cyber security threat warning; a quarantine function that isolates a function or subsystem of the vehicle; and a restore function that attempts to reverse one or more cyber security breach effect.

In addition to one or more of the features described above or below, or as an alternative, further embodiments could include where the one or more recovery actions further include an auto-command function that initiates a sequence of commands to return the vehicle to a known condition or location.

In addition to one or more of the features described above or below, or as an alternative, further embodiments could include initiating a request to clear sensitive data and transmit a mayday code based on determining that an unrecoverable loss of vehicle event is imminent.

According to further aspects of the invention, a cyber security system for a vehicle is provided. The cyber security system includes a memory operable to store a plurality of cyber security configuration data and to buffer data acquired from at least one communication bus of the vehicle. The cyber security system also includes a cyber security processor that, based on the cyber security configuration data, causes the cyber security system to monitor a plurality of parameters acquired from the at least one communication bus of the vehicle and filter the parameters to identify parameters of interest for cyber security threat detection. The cyber security processor further causes the cyber security system to perform an evaluation of the parameters of interest with respect to one or more of normal conditions and abnormal conditions to identify at least one likely cyber security threat in the vehicle based on identification of at least one condition that does not match the normal conditions or at least one condition that does match the abnormal conditions, and trigger one or more recovery actions based on identification of the at least one likely cyber security threat in the vehicle.

### BRIEF DESCRIPTION OF THE DRAWINGS

Referring now to the drawings wherein like elements are numbered alike in the several FIGURES, in which:

FIG. 1 schematically depicts a block diagram of a vehicle system network in accordance with an embodiment;

FIG. 2 schematically depicts a block diagram of a cyber security system and a vehicle computer system of the vehicle system network in accordance with an embodiment;

FIG. 3 schematically depicts a block diagram of a data flow of the cyber security system in accordance with embodiments; and

FIG. 4 schematically depicts a block diagram of a data flow for parameter evaluation in accordance with embodiments.

### DETAILED DESCRIPTION

Embodiments include a cyber security system for a vehicle. The cyber security system may be embodied in aircraft, terrestrial vehicles, watercraft, and/or known types of vehicles including manned vehicles, unmanned vehicles, and optionally piloted vehicles. In one embodiment, the cyber security system is installed in a helicopter. In alternate embodiments, the cyber security system is in an airplane, automobile, train, or boat. As a further alternative, the cyber security system can be implemented in an elevator system, where the vehicle is an elevator car. The cyber security system is configured to recognize the presence of malware and prevent/limit anomalous behavior of the vehicle in response to the malware. The cyber security system also resists attacks based on denial of service, attempts to upload corrupted software/data, and to tamper with the cyber security system. Monitoring can be performed at the system level, line replaceable unit level, and/or chip level.

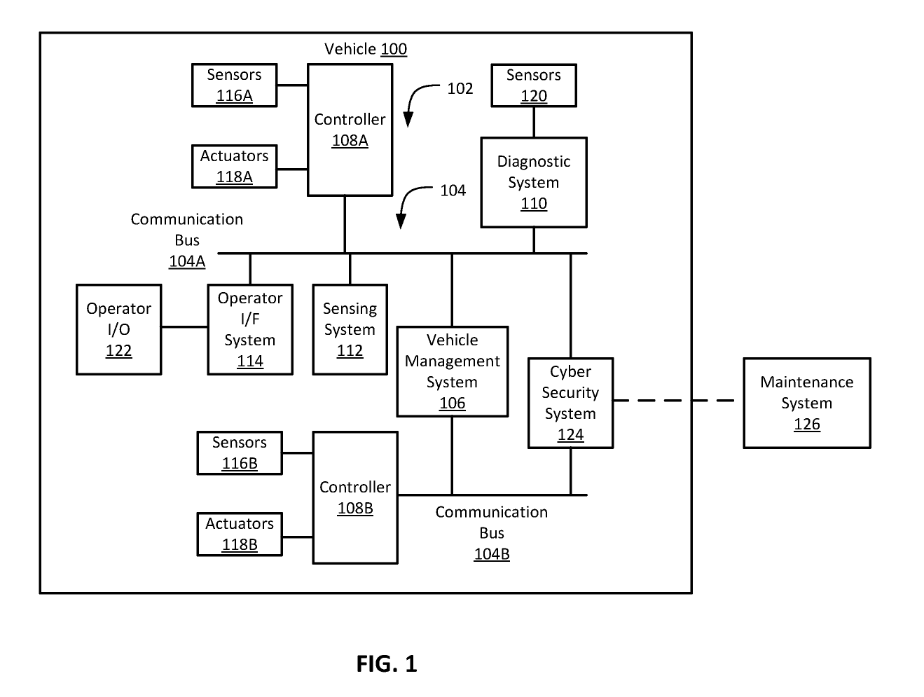

FIG. 1 schematically depicts a block diagram of a vehicle system network 102 of a vehicle 100 in accordance with an embodiment. The vehicle system network 102 can include one or more communication buses 104, such as communication buses 104A and 104B. The communication buses 104 may be partitioned based on different levels of security, redundancy, and/or communication protocol support. Examples of the communication buses 104 include buses compliant with ARINC standards, military bus standards, Ethernet standards, controller area network standards, and/or other standards known in the art. In the example of FIG. 1, a vehicle management system 106 is coupled to communication buses 104A and 104B. The vehicle management system 106 can provide high-level commands to coordinate actions between various subsystems of the vehicle system network 102, such as controllers 108A and 108B, a diagnostic system 110, a sensing system 112, and an operator interface system 114, as well as any other subsystems (not depicted) of the vehicle system network 102.

In the example of FIG. 1, the controllers 108A and 108B interface with sensors 116A, 116B and actuators 118A, 118B respectively. The controllers 108A and 108B can be redundant systems for increased fault tolerance or components of different subsystems of the vehicle 100, such as a flight management system and an engine control system in an aircraft embodiment. Examples of the sensors 116A, 116B can include analog or digital sensors to observe conditions of the vehicle 100 or external conditions of the vehicle 100, e.g., velocity, acceleration, temperature, strain, position, torque, altitude, and the like. Examples of the actuators 118A, 118B include motors, solenoids, relays, linear positioning devices, rotary positioning devices, and the like. The diagnostic system 110 may monitor various sensors 120 to monitor the health of the vehicle 100 and/or various subsystems of the vehicle 100. For instance, the sensors 120 can include vibration sensors (e.g., accelerometers), debris/damage monitoring sensors, temperature sensors, and the like. The sensing system 112 can include one or more smart sensing subsystems that can acquire and output sensed data on communication bus 104A, such as a radar altimeter in an aircraft embodiment or a proximity detection sensor in a ground or water based embodiment. The operator interface system 114 can drive outputs to and receive inputs from operator input/output (I/O) 122, such as steering signals, multi-function display drivers, analog interfaces, and/or discrete switches, including audio and/or video I/O.

In order to protect the vehicle 100 from cyber-attacks, the vehicle 100 also includes a cyber security system 124 that is coupled to the communication buses 104. The cyber security system 124 can recognize the presence of malware on the vehicle 100 by monitoring for anomalous behavior. The cyber security system 124 can trigger one or more recovery actions based on identifying at least one likely cyber security threat in the vehicle 100 as further described herein. The cyber security system 124 can also provide gatekeeping services with respect to communications with systems external to the vehicle system network 102. For instance, the cyber security system 124 can monitor and filter applications and data uploaded by a maintenance system 126. The maintenance system 126 may establish wired or wireless communication with the cyber security system 124 in attempting to update one or more aspects of the subsystems of the vehicle 100, such as software within the vehicle management system 106, controllers 108A, 108B, diagnostic system 110, sensing system 112, operator interface system 114, and/or cyber security system 124. The maintenance system 126 is typically a trusted computer system that can perform updates to programmable aspects of the vehicle 100. The cyber security system 124 provides a number of checks on commands, data, and/or application software uploaded by the maintenance system 126 in case the maintenance system 126 has been compromised with malware or is being spoofed by a hostile computer system.

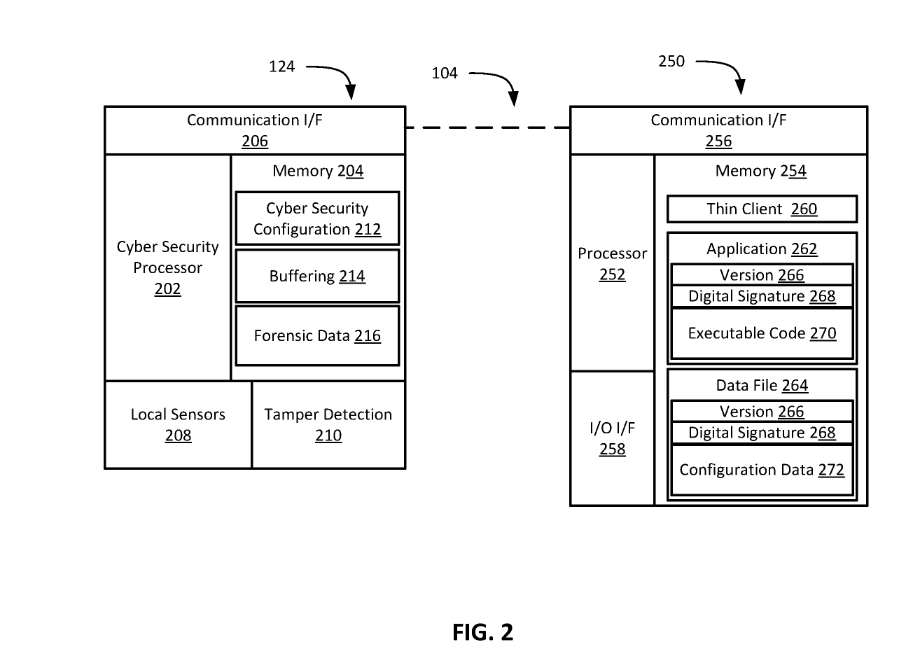

FIG. 2 schematically depicts a block diagram of the cyber security system 124 of FIG. 1 and a vehicle computer system 250 of the vehicle system network 102 of FIG. 1 in accordance with an embodiment. The vehicle computer system 250 is a generic example that can embody one or more of the vehicle management system 106, controllers 108, diagnostic system 110, sensing system 112, and/or operator interface system 114 of FIG. 1. In the example of FIG. 2, the cyber security system 124 includes a cyber security processor 202, memory 204, a communication interface 206, one or more local sensors 208, and tamper detection 210. The cyber security processor 202 can be any type or combination of computer processors, such as a microprocessor, microcontroller, digital signal processor, application specific integrated circuit, programmable logic device, and/or field programmable gate array to perform cyber security processing.

The memory 204 is an example of a non-transitory computer readable storage medium tangibly embodied in the cyber security system 124 including executable instructions and/or data stored therein, for instance, as firmware. Examples of instructions and/or data that can be stored in the memory 204 include cyber security configuration 212, buffering 214, and forensic data 216. Application code for implementing core cyber security functions may be included within the memory 204 or hardcoded into the cyber security processor 202. The memory 204 can include a combination of volatile and/or nonvolatile memory. The cyber security configuration 212 can include customization parameters that may include parameter identifiers, system information, limits, conditions, and the like to configure the cyber security system 124 for a specific application. The buffering 214 can include temporary storage for parameter values and/or application/data uploads to be verified prior to committing uploaded values to one or more subsystems of the vehicle system network 102. The forensic data 216 can include recorded observations and results associated with the evaluation of parameters of interest when monitoring one or more subsystems of the vehicle 100, such as the vehicle computer system 250.

The local sensors 208 can include one or more independent instances of sensors similar to the sensors 116A, 116B, sensors 120, and/or sensors (not depicted) of the sensing system 112 of FIG. 1. For instance, the local sensors 208 can include one or more accelerometers to independently detect motion of the vehicle 100. The local sensors 208 may also include a “dead-man switch” to detect that vehicle 100 is likely operating in an uncontrolled state, e.g., a rapid descent of an aircraft or uncontrolled acceleration of a ground-based vehicle. The local sensors 208 may also include an internal switch or other means within the cyber security system 124 to detect that an enclosure of the cyber security system 124 has been accessed. For instance, the tamper detection 210 can monitor the local sensors 208 to determine whether a failed electronic authorization attempt has been detected (e.g., failed authorization code) or a physical attempt to open the cyber security system 124 has been detected (e.g., using a pressure switch).

The communication interface 206 can communicate with the vehicle computer system 250 via the communication buses 104 and/or with the maintenance system 126 of FIG. 1 via external communication links. The vehicle computer system 250 can include a processor 252, memory 254, communication interface 256, and an input/output interface 258. The processor 252 can be any type or combination of computer processors, such as a microprocessor, microcontroller, digital signal processor, application specific integrated circuit, programmable logic device, and/or field programmable gate array. The memory 254 is an example of a non-transitory computer readable storage medium tangibly embodied in the vehicle computer system 250 including executable instructions and/or data stored therein, for instance, as firmware. Examples of instructions and/or data that can be stored in the memory 254 include a thin client 260, one or more application 262, and one or more data file 264. The thin client 260 can support communication with cyber security system 124 to receive security-sensitive protocols to manage uploading and integrity checks of the one or more application 262 and data file 264.

In the example of FIG. 2, application 262 and data file 264 each include a version 266 and digital signature 268 to assist in resisting malware attacks by confirming that the values match expected values. For example, when the maintenance system 126 of FIG. 1 attempts to update executable code 270 of application 262, the cyber security system 124 can perform a confirmation of the version 266 and/or the digital signature 268 of the application 262 prior to allowing a modification to the executable code 270 of the application 262. Similarly, the cyber security system 124 can perform a confirmation of the version 266 and/or the digital signature 268 of the data file 264 prior to allowing a modification to configuration data 272 of the data file 264.

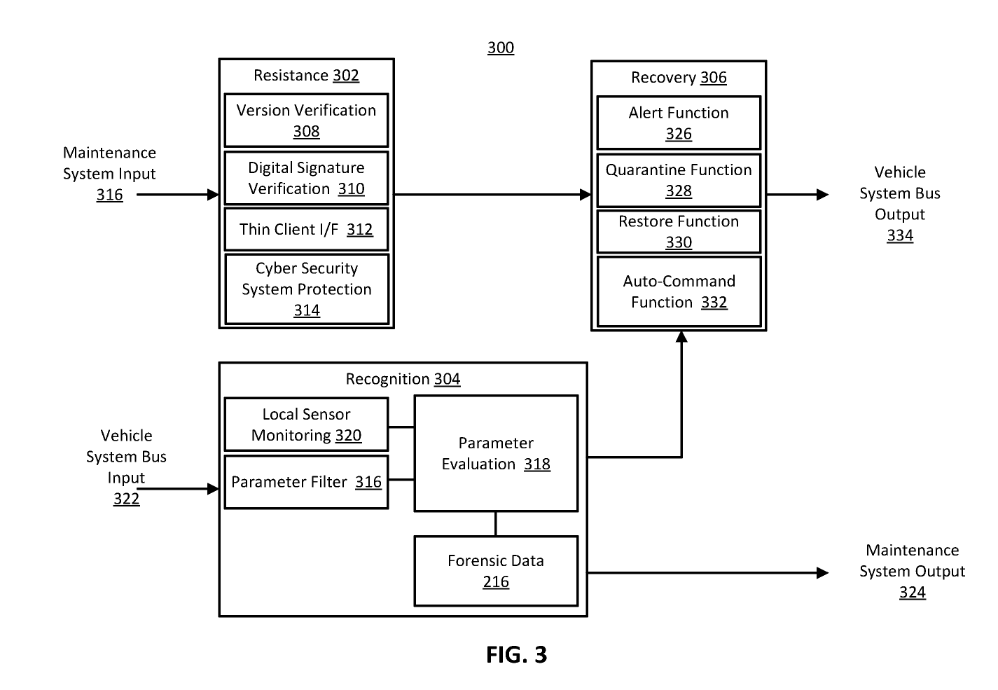

FIG. 3 schematically depicts a block diagram of a data flow 300 of the cyber security system 124 of FIG. 1 in accordance with embodiments. In the example of FIG. 3, the data flow 300 includes a resistance function 302, a recognition function 304, and a recovery function 306. The resistance function 302 can include version verification 308, digital signature verification 310, thin client interface 312, and/or cyber security system protection 314. In one embodiment, the resistance function 302 monitors maintenance system input 316 from the maintenance system 126 of FIG. 1. The version verification 308 can include version checking logic to ensure that the version 266 of FIG. 2 of an application 262 and/or data file 264 complies with minimum version requirements which can include formatting, exact version values, acceptable version range values and/or other expected/unexpected value checks. The digital signature verification 310 can include a check of the digital signature 268 of the application 262 and/or data file 264 of FIG. 2 for an expected or unexpected value. The thin client interface 312 can establish communication with the thin client 260 of FIG. 2 to confirm that attempted updates to the vehicle system computer 250 comply with formatting and content requirements before propagating changes over the communication system buses 104. The cyber security system protection 314 can include checks to ensure that software/firmware updates to the cyber security system 124 meet formatting and data requirements before allowing updates. The cyber security system protection 314 can also include checks for attempts at tampering with the cyber security system 124, such as physically accessing an enclosure of the cyber security system 124 which may be detected by tamper detection 210 using at least one of the local sensors 208 of FIG. 2. One or more recovery actions of the recovery function 306 can be triggered by the resistance function 302 in response to a detected threat, such as identifying at least one unexpected value for one or more of the version 266 and the digital signature 268 of FIG. 2.

The recognition function 304 can include a parameter filter 316 and parameter evaluation 318 that may utilize local sensor monitoring 320 as part of the evaluation process of parameters acquired from at least one communication bus 104 of the vehicle 100 of FIG. 1 as vehicle system bus input 322. Observations and results of the parameter evaluation 318 may be stored in the forensic data 216 to send to the maintenance system 126 of FIG. 1 as maintenance system output 324 in response to receiving an authorized (i.e., authenticated) request from the maintenance system 126. Results of the parameter evaluation 318 can also be provided to the recovery function 306 to trigger one or more recovery actions. Thus, the cyber security system 124 can monitor a plurality of parameters acquired from at least one communication bus of the vehicle 100, filter the parameters to identify parameters of interest for cyber security threat detection, perform an evaluation of the parameters of interest to identify at least one likely cyber security threat in the vehicle 100, and trigger one or more recovery actions based on identifying the at least one likely cyber security threat in the vehicle 100.

The recovery function 306 can include, for example, an alert function 326, a quarantine function 328, a restore function 330, and/or an auto-command function 332 to drive vehicle system bus output 334 on one or more of the communication buses 104 of FIG. 1. The alert function 326 can trigger an alert to one or more systems of the vehicle 100 of FIG. 1 as a cyber security threat warning. For instance, the alert function 326 may drive a warning message on the operator I/O 122 via one or more of the communication buses 104 of FIG. 1. The quarantine function 328 can isolate a function or subsystem of the vehicle 100 of FIG. 1. For example, the quarantine function 328 can shut down operation of a non-critical function or subsystem when a cyber security threat has been identified to prevent further propagation of the threat, e.g., via automated or operator requested selected depowering of the function or subsystem. The restore function 330 attempts to reverse one or more cyber security breach effects. For example, a copy of last known good software and/or configuration settings can be retained to replace corrupted software and/or configuration data using buffering 214 of FIG. 2 or portions of the memory 254 of FIG. 2. The restore function 330 may attempt to compensate for degraded performance within the vehicle 100 by reallocating monitoring and control functions between various subsystems. Where corrupted data values can be repaired using error correction codes, the restore function 330 may manage sequencing of error correction, switching to a backup system, and switching from the backup system upon confirming that all corrupted values have been corrected.

The auto-command function 332 can initiate a sequence of commands to return the vehicle 100 of FIG. 1 to a known condition or location. For example, where the vehicle 100 is autonomously controlled, the auto-command function 332 can send a return-to-base command to the vehicle management system 106 of FIG. 1. The auto-command function 332 may alternatively initiate a request to seek a closest safe landing site when the vehicle 100 is an autonomously controlled aircraft.

For embodiments of the vehicle 100 of FIG. 1 that include sensitive/classified data, the recovery function 306 may initiate a request to clear sensitive data and transmit a mayday code based on determining that an unrecoverable loss of vehicle event is imminent. The request to clear sensitive data can be sent to vehicle computer system 250 via one or more of the communication buses 104 of FIG. 1 to zero-out or otherwise clear all or portions of the memory 254.

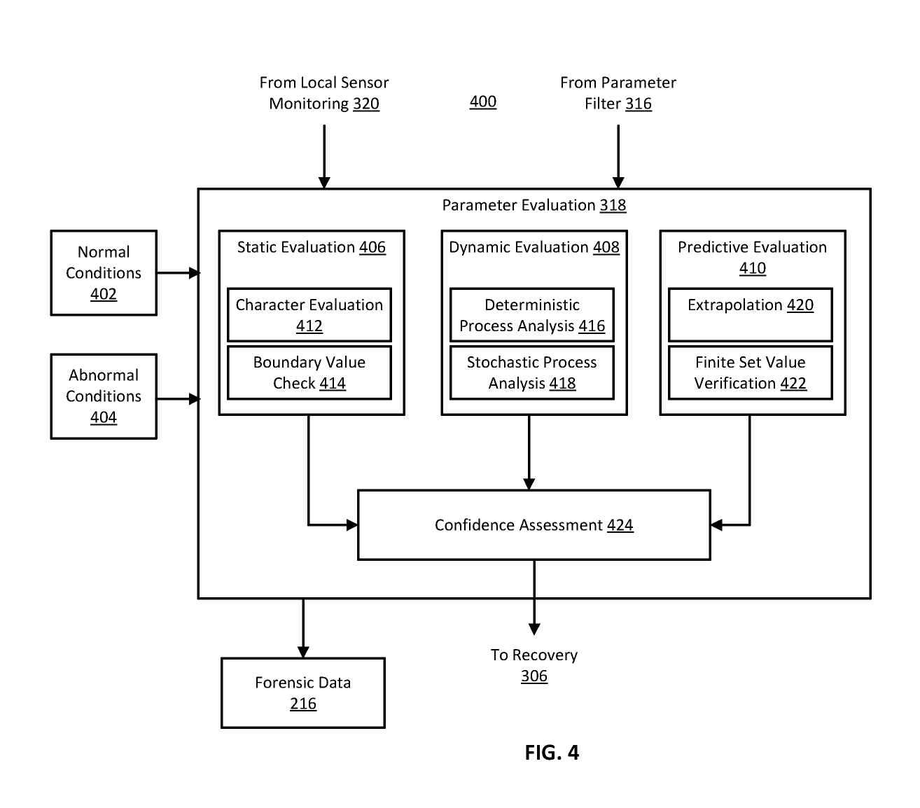

FIG. 4 schematically depicts a block diagram of a data flow 400 for the parameter evaluation 318 of FIG. 3 in accordance with embodiments. In the data flow 400, the parameter evaluation 318 performs an evaluation of parameters of interest from parameter filter 316 with respect to one or more of normal conditions 402 and abnormal conditions 404 to identify at least one likely cyber security threat in the vehicle 100 of FIG. 1 based on identifying at least one condition that does not match the normal conditions 402 or at least one condition that does match the abnormal conditions 404. The normal conditions 402 can be defined in terms of static values, acceptable ranges, acceptable rates, acceptable sequences, and the like on an individual parameter basis or with respect to other parameters (e.g., multiple related parameters trending in the same direction). The abnormal conditions 404 can be defined in terms of unacceptable static values, out-of-range values, unacceptable rates, known unacceptable sequences, and the like on an individual parameter basis or with respect to other parameters (e.g., multiple related parameters trending in different directions). The normal conditions 402 and abnormal conditions 404 can be defined through the parameter filter 316 and/or in the cyber security configuration 212 of FIG. 2.

The parameter evaluation 318 can include a static evaluation 406, a dynamic evaluation 408, and a predictive evaluation 410 of the parameters of interest with respect to one or more of the normal conditions 402 and the abnormal conditions 404 as separately defined for each of the static evaluation 406, the dynamic evaluation 408, and the predictive evaluation 410. Evaluations performed by the parameter evaluation 318 can be performed with respect to the parameter filter 316 and/or the local sensor monitoring 320, where the local sensor monitoring may be used to determine an operating condition of the vehicle 100 of FIG. 1 and/or a deviation with respect to one or more of the parameters of interest.

The static evaluation 406 can include performing a character evaluation 412 and/or a boundary value check 414 of at least one of the parameters of interest. The character evaluation 412 can include in-range comparisons with regard to the state of various parameters with respect to each other. For instance, a deviation greater than a predetermined percentage between related parameters that are both identified as being healthy may indicate that the data is being manipulated. The boundary value check 414 can check parameters against expected operating ranges for normal operation.

The dynamic evaluation 408 can include performing a deterministic process analysis 416 and/or a stochastic process analysis 418 on at least one of the parameters of interest. The deterministic process analysis 416 can perform rate checks, frequency checks, phase alignment checks, and the like for parameters individually and with respect to multiple parameters. The stochastic process analysis 418 may use statistical-based analysis and comparisons for dynamic trending analysis and to establish a statistical likelihood of a cyber security threat.

The predictive evaluation 410 can include performing an extrapolation 420 and/or finite set value verification 422 of at least one of the parameters of interest. The extrapolation can include extending current trends of parameters to determine a likelihood of trending toward one of the abnormal conditions 404. The finite set value verification 422 can establish expected sequencing patterns based on observed repetitions under normal conditions 402 to assist in identifying unexpected sequencing changes and trends.

The parameter evaluation 318 can perform a confidence assessment 424 with respect to one or more result of the static evaluation 406, the dynamic evaluation 408, and the predictive evaluation 410. The confidence assessment 424 assigns a likelihood value based on identifying at least one likely cyber security threat by the static evaluation 406, the dynamic evaluation 408, and/or the predictive evaluation 410. As one example, a threat counter can be incremented when the normal conditions 402 are not met and/or the abnormal conditions 404 are met over a period of time, with a greater count value indicating a higher likelihood of a cyber security threat existing within the vehicle 100 of FIG. 1. Parameters of interest can be mapped to specific subsystems, and combinations of parameter issues can map to likely problems with associated recovery actions. The results of the confidence assessment 424, which may also identify specific desired recovery actions, can be sent to the recovery function 306 of FIG. 3 and captured in forensic data 216.

Technical effects include providing resistance to cyber security threats, recognition of cyber security threats, and recovery from cyber security threats in a vehicle. Rapid and real-time reactions to cyber security threats can minimize the risk of damage and ensure the safety of vehicle occupants and those in proximity to the vehicle.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method of providing cyber security for a vehicle, the method comprising:
monitoring, by a cyber security system of the vehicle, a plurality of parameters acquired from at least one communication bus of the vehicle;
filtering the parameters to identify parameters of interest for cyber security threat detection;
performing an evaluation of the parameters of interest with respect to one or more of normal conditions and abnormal conditions to identify at least one likely cyber security threat in the vehicle based on identifying at least one condition that does not match the normal conditions or at least one condition that does match the abnormal conditions; and
triggering one or more recovery actions based on identifying the at least one likely cyber security threat in the vehicle.

2. The method of claim 1, wherein the evaluation of the parameters of interest comprises performing one or more of: a static evaluation, a dynamic evaluation, and a predictive evaluation of the parameters of interest with respect to one or more of the normal conditions and the abnormal conditions as separately defined for each of the static evaluation, the dynamic evaluation, and the predictive evaluation.

3. The method of claim 2, wherein the static evaluation comprises performing at least one of a character evaluation and a boundary value check of at least one of the parameters of interest; the dynamic evaluation comprises performing at least one of a deterministic process analysis and a stochastic process analysis on at least one of the parameters of interest; and the predictive evaluation comprises performing at least one of an extrapolation and a finite set value verification of at least one of the parameters of interest.

4. The method of claim 2, further comprising:
performing a confidence assessment with respect to one or more result of the static evaluation, the dynamic evaluation, and the predictive evaluation; and
determining the one or more recovery actions to take within the vehicle based on a result of the confidence assessment, wherein the confidence assessment assigns a likelihood value to the at least one likely cyber security threat.

5. The method of claim 1, further comprising:
monitoring at least one local sensor, by the cyber security system, to determine one or more of: an operating condition of the vehicle; a deviation with respect to one or more of the parameters; and an attempt to tamper with the cyber security system.

6. The method of claim 1, further comprising:
receiving an upload comprising one or more of an application and a data file from a maintenance system;
checking one or more of a version and a digital signature associated with one or more of the application and the data file; and
triggering at least one of the one or more recovery actions based on identifying at least one unexpected value for one or more of the version and the digital signature associated with one or more of the application and the data file.

7. The method of claim 1, further comprising:
recording observations and results associated with the evaluation of the parameters of interest as forensic data; and
outputting the forensic data from the cyber security system based on receiving an authorized request.

8. The method of claim 1, wherein the one or more recovery actions comprise one or more of: an alert function that triggers an alert to one or more systems of the vehicle as a cyber security threat warning; a quarantine function that isolates a function or subsystem of the vehicle; and a restore function that attempts to reverse one or more cyber security breach effect.

9. The method of claim 8, wherein the one or more recovery actions further comprise an auto-command function that initiates a sequence of commands to return the vehicle to a known condition or location.

10. The method of claim 1, further comprising:
initiating a request to clear sensitive data and transmit a mayday code based on determining that an unrecoverable loss of vehicle event is imminent.

11. A cyber security system for a vehicle, the cyber security system comprising:
a memory operable to store a plurality of cyber security configuration data and to buffer data acquired from at least one communication bus of the vehicle; and
a cyber security processor that, based on the cyber security configuration data, causes the cyber security system to:
monitor a plurality of parameters acquired from the at least one communication bus of the vehicle;
filter the parameters to identify parameters of interest for cyber security threat detection;
perform an evaluation of the parameters of interest with respect to one or more of normal conditions and abnormal conditions to identify at least one likely cyber security threat in the vehicle based on identification of at least one condition that does not match the normal conditions or at least one condition that does match the abnormal conditions; and
trigger one or more recovery actions based on identification of the at least one likely cyber security threat in the vehicle.

12. The cyber security system of claim 11, wherein the evaluation of the parameters of interest comprises one or more of: a static evaluation, a dynamic evaluation, and a predictive evaluation of the parameters of interest with respect to one or more of the normal conditions and the abnormal conditions as separately defined for each of the static evaluation, the dynamic evaluation, and the predictive evaluation.

13. The cyber security system of claim 12, wherein the static evaluation comprises at least one of a character evaluation and a boundary value check of at least one of the parameters of interest; the dynamic evaluation comprises at least one of a deterministic process analysis and a stochastic process analysis on at least one of the parameters of interest; and the predictive evaluation comprises at least one of an extrapolation and a finite set value verification of at least one of the parameters of interest; and further wherein a confidence assessment is performed with respect to one or more result of the static evaluation, the dynamic evaluation, and the predictive evaluation, and the one or more recovery actions are based on a result of the confidence assessment, wherein the confidence assessment assigns a likelihood value to the at least one likely cyber security threat.

14. The cyber security system of claim 11, further comprising at least one local sensor, where the cyber security processor is further configured to monitor the at least one local sensor to determine one or more of: an operating condition of the vehicle; a deviation with respect to one or more of the parameters; and an attempt to tamper with the cyber security system.

15. The cyber security system of claim 11, wherein the one or more recovery actions comprise one or more of: an alert function that triggers an alert to one or more systems of the vehicle as a cyber security threat warning; a quarantine function that isolates a function or subsystem of the vehicle; a restore function that attempts to reverse one or more cyber security breach effect; and an auto-command function that initiates a sequence of commands to return the vehicle to a known condition or location.
